(19) United States
(12) Patent Application Publication
(10) Pub. No.: US 2018/0362891 A1
(43) Pub. Date: Dec. 20, 2018

(54) OPTIMIZED SURFACTANT-ENZYME MIXTURES

(71) Applicant: Henkel AG & Co. KGaA, Duesseldorf (DE)

(72) Inventors: Michael Dreja, Neuss (DE); Hendrik Hellmuth, Darmstadt (DE); Alexander Schulz, Essen (DE)

(73) Assignee: Henkel AG & Co. KGaA, Duesseldorf (DE)

(21) Appl. No.: 16/108,851

(22) Filed: Aug. 22, 2018

Related U.S. Application Data
(63) Continuation of application No. PCT/EP2017/053630, filed on Feb. 17, 2017.

(30) Foreign Application Priority Data
Feb. 24, 2016 (DE) 102016202804.9

(51) Int. Cl. C11D 3/386; C11D 3/37; C11D 3/00; C11D 1/83

(52) U.S. Cl. CPC C11D 3/38618; C11D 3/3723; C11D 11/0017; C11D 1/83; C11D 3/0036

(57) ABSTRACT

The present invention relates to the field of enzyme technology, in particular the optimization of surfactant-enzyme mixtures, as used, for example, in washing or cleaning agents. The invention relates to an agent, in particular a washing or cleaning agent, which contains at least one enzyme and a special surfactant mixture. The present invention further relates to a method for cleaning textiles or hard surfaces and to the use of the agent according to the invention for removing stains.

### FIELD OF THE INVENTION

The present invention relates to the field of enzyme technology, in particular optimization of surfactant-enzyme mixtures, as used in washing or cleaning agents, for example. The invention relates to an agent, in particular a washing or cleaning agent, which contains at least one enzyme and a specific surfactant mixture. The present invention further relates to a method for cleaning textiles or hard surfaces, and to the use of the agent according to the invention for removing stains.

### BACKGROUND OF THE INVENTION

Current washing agents are often used in liquid form and/or at low temperatures. Under these conditions, the surfactant system is used above all for removing greasy stains. Conventional surfactants used for this purpose are petrochemical-based LAS (linear alkylbenzene sulfonate) or SAS (secondary alkyl sulfonate) or MES (methyl ester sulfonate), and petrochemically or oleochemically obtained non-ionic surfactants, such as fatty alcohol ethoxylates or amine oxides. Betaines, amino acid-based surfactants or biosurfactants can also be used, for example. Hydrolases, i.e. proteases, amylases, lipases, mannanases, pectinases, cellulases, etc., are conventionally used as enzymes. For use in a washing or cleaning agent, stability during storage and cleaning performance are largely dependent on the mixture of the individual components. Therefore, an optimized combination of both surfactants/surfactant mixtures and enzymes/enzyme mixtures is required in order for the individual ingredients to have optimized stability and cleaning performance.

It has now surprisingly been found that the use of certain surfactants or surfactant mixtures in specific mixture ratios to particular enzymes or enzyme mixtures leads to an agent, in particular a washing or cleaning agent, having improved stability and improved cleaning performance. It has been found that the combinations which are particularly advantageous are those in which the proportion of structural aliphatic units, which are typical of FAEO, FAEOS and SAS, is relatively high, and the proportion of structural aromatic units, which are typical of LAS, is relatively low. Based on these results, a formula for a surfactant mixture has been established which provides for optimum cleaning performance and which, at the same time, is particularly gentle on the enzymes contained in the agents according to the invention.

### BRIEF SUMMARY OF THE INVENTION

A first object of the present invention is therefore an agent, in particular a washing or cleaning agent, containing
(a) at least one enzyme, and
(b) a surfactant mixture,
wherein
   (i) the surfactant mixture contains at least one non-ionic surfactant and at least one anionic surfactant,
   (ii) the surfactant mixture contains less than 10 wt. % of surfactants, based on the total weight of the agent, which contain an aromatic hydrocarbon structural unit and/or a carboxylate structural unit, and
   (iii) the surfactant mixture meets the condition

20X₁−30X₂+40X₃−80X₄+X₅−20X₆>0
wherein
X₁ corresponds to the total number of aliphatic hydrocarbon structural units of all surfactants,
X₂ corresponds to the total number of aromatic hydrocarbon structural units of all surfactants,
X₃ corresponds to the total number of ethylene oxide structural units of all surfactants,
X₄ corresponds to the total number of sulf(on)ate structural units (SO₃⁻/SO₄⁻) of all surfactants,
X₅ corresponds to the total number of structural units selected from the group consisting of C═O, N—CH₃, N(CH₃)₂ and N═O of all surfactants,
X₆ corresponds to the total number of carboxylate structural units (COO⁻) of all surfactants, and
wherein
   (i) the total number of the relevant structural unit equates to the sum of the amounts of a given structural unit in various given surfactant populations, and
   (ii) the amount of a given structural unit in a given surfactant population (M_{TP}) is the product of the number of occurrences of the given structural unit in an individual surfactant of the given surfactant population (A_{TP}) and the substance proportion of the given surfactant population (S_{TP}) relative to the total amount of the surfactant mixture, wherein this corresponds to M_{TP}=A_{TP}·S_{TP}.

A further object of the present invention is the use of an agent according to the invention for removing stains.

Finally, the present invention is also directed to a method for cleaning textiles or hard surfaces in which an agent according to the invention is used.

These and other aspects, features and advantages of the invention will become apparent to a person skilled in the art through the study of the following detailed description and claims. Any feature from one aspect of the invention can be used in any other aspect of the invention. Furthermore, it will readily be understood that the examples contained herein are intended to describe and illustrate, but not limit, the invention and that, in particular, the invention is not limited to these examples. Numerical ranges that are given in the format “from x to y” include the cited values. If several preferred numerical ranges are indicated in this format, it is self-evident that all ranges that result from the combination of the various endpoints are also included.

“At least one”, as used herein, means one or more, i.e., one, two, three, four, five, six, seven, eight, nine, or more. In relation to an ingredient, the expression refers to the type of ingredient and not to the absolute number of molecules. Together with weight data, the expression refers to all compounds of the indicated type that are contained in the composition/mixture, that is to say the composition does not contain any other compounds of this type beyond the indicated amount of the corresponding compounds.

Unless explicitly indicated otherwise, all percentages that are cited in connection with the compositions described herein refer to wt. %, based in each case on the relevant mixture.

“Substantially free of” or “free of”, as used herein, means that the ingredient in question is contained in the corresponding phase or the corresponding agent in a negligible amount, in particular in an amount which is not sufficient for the typical functionality of the ingredient.

One object of the invention is an agent, in particular a washing or cleaning agent, which is characterized in that it contains an enzyme and a surfactant mixture, as defined herein in each case. This covers all conceivable types of washing or cleaning agents, including both concentrates and agents to be used in undiluted form, for use on a commercial scale in washing machines or for washing or cleaning by hand. These agents include, for example, washing agents for textiles, carpets or natural fibers for which the term “washing agent” is used. These also include, for example, dishwashing detergents for dishwashers or manual dishwashing detergents or cleaners for hard surfaces, such as metal, glass, porcelain, ceramics, tiles, stone, coated surfaces, plastics materials, wood or leather for which the term “cleaning agent” is used, i.e. in addition to manual and automatic dishwashing detergents, also, for example, abrasive cleaners, glass cleaners, WC rimblocks, etc. Within the scope of the invention, the washing and cleaning agents also include auxiliary washing agents, which are added to the actual washing agent when washing textiles manually or using a machine in order to achieve an additional effect. Furthermore, within the scope of the invention, washing and cleaning agents also include textile pre-treatment and post-treatment agents, i.e. agents with which the piece of laundry comes into contact before it is actually washed, for example in order to loosen stubborn stains, and also agents which impart other desirable properties to the laundry, for example softness to touch, crease resistance or low static charge, in a step that comes after the actual textile washing process. The agents mentioned last include, inter alia, softeners.

Agents according to the invention contain at least one enzyme. The enzyme may be a hydrolytic enzyme or another enzyme in a concentration that is expedient in terms of the effectiveness of the agent. One embodiment of the invention thus relates to agents which comprise one or more enzymes. All enzymes which can develop catalytic activity in the agent according to the invention, in particular a protease, amylase, cellulase, hemicellulase, mannanase, tannase, xylanase, xanthanase, xyloglucanase, β-glucosidase, pectinase, carrageenase, perhydrolase, oxidase, oxidoreductase or a lipase, and mixtures thereof, can preferably be used as enzymes. Enzymes are contained in the agent advantageously in an amount of from 1×10⁻⁸ to 5 wt. % in each case, based on the active protein. Each enzyme is contained in agents according to the invention in an amount of, in order of increasing preference, from 1×10⁻⁷ to 3 wt. %, from 0.00001 to 1 wt. %, from 0.00005 to 0.5 wt. %, from 0.0001 to 0.1 wt. %, and most particularly preferably from 0.0001 to 0.05 wt. %, based on the active protein. The enzymes particularly preferably have synergistic cleaning performances with respect to particular stains or marks, i.e. the enzymes contained in the agent composition assist one another in terms of the cleaning performance thereof. Synergistic effects can occur not only between different enzymes, but also between one or more enzymes and other ingredients of the agent according to the invention.

The amylase(s) is/are preferably an a-amylase. The hemicellulase is preferably a pectinase, a pullulanase and/or a mannanase. The cellulase is preferably a cellulase mixture or a single-component cellulase, preferably or primarily an endoglucanase and/or a cellobiohydrolase. The oxidoreductase is preferably an oxidase, in particular a choline oxidase, or a perhydrolase.

The proteases used are preferably alkaline serine proteases. Said proteases act as non-specific endopeptidases, i.e. they hydrolyze any acid amide bonds that are within peptides or proteins and thereby cause the breakdown of protein-containing stains on the item to be cleaned. Their pH optimum is usually in the highly alkaline range. In preferred embodiments, the enzyme contained in the agent according to the invention is a protease.

The enzymes used in the present case can be naturally occurring enzymes or enzymes that have been altered on the basis of naturally occurring enzymes by means of one or more mutations in order to positively influence desired properties, such as catalytic activity, stability or disinfecting performance.

In preferred embodiments of the invention, the enzyme is contained in the agent according to the invention in the form of an enzyme product and in an amount of from 0.01 to 10 wt. %, preferably from 0.01 to 5 wt. %, based on the total weight of the agent. The active protein content is preferably in the range of from 0.00001 to 1 wt. %, in particular from 0.0001 to 0.2 wt. %, based on the total weight of the agent.

The protein concentration can be determined using known methods, for example the BCA method (bicinchoninic acid; 2,2′-bichinolyl-4,4′-dicarboxylic acid) or the Biuret method. The active protein concentration is determined, in this respect, by titrating the active centers using a suitable irreversible inhibitor (for proteases, phenylmethylsulfonyl fluoride (PMSF), for example), and determining the residual activity (cf. M. Bender et al., J. Am. Chem. Soc. 88, 24 (1966), pages 5890-5913).

In the agents described herein, the enzymes that can be used can also be formulated together with accompanying substances, from fermentation for example. In liquid formulations, the enzymes are preferably used as liquid enzyme formulation(s).

The enzymes are generally not made available in the form of the pure protein, but rather in the form of stabilized, storable and transportable preparations. These ready-made preparations include, for example, the solid preparations obtained by means of granulation, extrusion or lyophilization or, particularly in the case of liquid or gel agents, solutions of the enzymes which are advantageously maximally concentrated, have a low water content, and/or are supplemented with stabilizers or other auxiliary agents.

Alternatively, for both solid and liquid dosage forms, the enzymes can be encapsulated, for example by means of spray-drying or extrusion of the enzyme solution together with a preferably natural polymer or in the form of capsules, for example those in which the enzymes are enclosed in a set gel, or in those of the core-shell type in which an enzyme-containing core is coated with a water, air, and/or chemical-impermeable protective layer. In the case of overlaid layers, other active ingredients, such as stabilizers, emulsifiers, pigments, bleaching agents, or dyes, can be additionally applied. Capsules of this kind are applied using inherently known methods, for example by means of shaking or roll granulation or in fluidized bed processes. Granulates of this kind are advantageously low in dust, for example due to the application of polymeric film-formers, and stable in storage due to the coating.

Moreover, it is possible to formulate two or more enzymes together, so that a single granulate has several enzyme activities.

In various embodiments, the agent according to the invention can comprise one or more enzyme stabilizers.

In various embodiments, anionic surfactants, non-ionic surfactants and mixtures thereof, as well as cationic, zwitterionic and amphoteric surfactants, in particular, are possible surfactants contained in the surfactant mixture. The surfactant mixture contained in the agent according to the invention comprises at least one surfactant from the group of anionic surfactants and at least one surfactant from the group of non-ionic surfactants. The surfactant mixture also contains less than 10 wt. % of surfactants (based on the total weight of the agent) which contain aromatic hydrocarbon structural units, such as phenyl or benzyl groups, and surfactants containing carboxylate groups, such as soaps.

The term “carboxylate” or “carboxylate structural unit”, as used interchangeably herein, refers to a group of formula —COO⁻. Examples of surfactants that contain carboxylate groups of this kind are soaps, i.e. in particular alkali metal salts of fatty acids, such as C₁₀₋₂₀ fatty acids. Carboxylate groups of this kind are generally formed during deprotonation/neutralization of carboxylic acids.

The term “aromatic hydrocarbon functional group” or “aromatic hydrocarbon structural unit”, as used interchangeably herein, refers to a molecule which contains at least one ring system which, in accordance with Hücker's rule, contains 4n+2 (n=0, 1, 2, . . . ) delocalized electrons in conjugated double bonds, free electron pairs or unoccupied p-orbitals.

Within the meaning of the invention, an “aliphatic hydrocarbon functional group” or “aliphatic hydrocarbon structural unit”, as used interchangeably herein, is every linear, branched or cyclic alkyl, alkenyl or alkinyl group.

Within the meaning of the present invention, an “ethylene oxide structural unit” is a group described by the following formula: —CH₂CH₂—O—. If several ethylene oxide units are present, i.e. if the structural unit has the formula —(CH₂CH₂—O)ₙ—, where n is an integer, typically from 1 to 50, each of the units is counted separately for the purpose of determining whether the condition according to the invention is met. This means that a surfactant having 2 EO, i.e. —(CH₂CH₂—O)₂—, has two ethylene oxide structural units within the meaning of the invention.

A “sulfate structural unit” is a group contained in a particular molecule that is described by the following formula: —O—SO₃⁻.

A “sulfonate structural unit” is described by the following formula: —SO₃⁻.

### DETAILED DESCRIPTION OF THE INVENTION

Within the meaning of the present invention, the total number of a given structural unit relates to the presence of this particular structural unit in all surfactants present in the surfactant mixture used. If this structural unit is present in a specific surfactant twice, for example, independently of one another, said structural unit is also counted twice for this type of surfactant. The total number of the given structural unit in the surfactant mixture is determined from the sum of the number/amount of said structural unit in the various surfactant types/surfactant populations of the surfactant mixture. A “surfactant type” or “surfactant population”, as used herein, refers to the total of all molecules that have an identical chemical structure. The number/amount of a given structural unit in a given surfactant population is abbreviated to M_{TP}. M_{TP} is calculated from the product of the number of occurrences of the given structural unit in an individual surfactant of the given surfactant population and the substance proportion of the given surfactant population relative to the total amount of the surfactant mixture. The number of occurrences of the given structural unit in an individual surfactant of the given surfactant population is abbreviated to A_{TP}. The substance proportion is defined as the value of the quotient of the substance amount of the given surfactant population to the total substance amount of all surfactants in the surfactant mixture. The substance proportion is abbreviated to S_{TP}. Therefore, the number/amount of a given structural unit in a given surfactant population M_{TP} is calculated using the following calculation formula:

M_{TP}=A_{TP}·S_{TP}

Examples of the calculation are described below in connection with specific surfactants.

Suitable compounds from the class of anionic surfactants are those of formula (I)

R—SO₃⁻X⁺ (I)

In formula (I), R stands for a linear or branched unsubstituted alkyl aryl functional group. X stands for a monovalent cation or the n-th part of an n-valent cation, the alkali metal ions, including Na⁺ or K⁺, being preferred in this case, with Na⁺ being particularly preferred. Other cations X⁺ may be selected from NH4⁺, ½ Zn²⁺, ½ Mg²⁺, ½ Ca²⁺, ½ Mn²⁺, and mixtures thereof.

“Alkyl aryl”, as used herein, refers to organic functional groups which consist of an alkyl functional group and an aromatic functional group. Typical examples of functional groups of this kind include, but are not limited to, alkylbenzene functional groups, such as benzyl, butylbenzene functional groups, nonylbenzene functional groups, decylbenzene functional groups, undecylbenzene functional groups, dodecylbenzene functional groups, tridecylbenzene functional groups, and the like.

In various embodiments, surfactants of this kind are selected from linear or branched alkylbenzene sulfonates of formula (A-1)

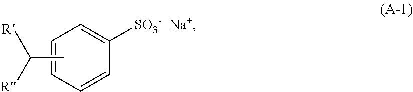

in which R′ and R″ together contain 9 to 19, preferably 11 to 15 and in particular 11 to 13, C atoms. A very particularly preferred representative can be described by formula (A-1a):

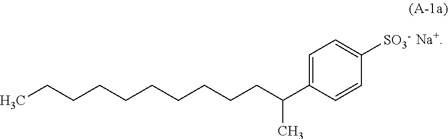

In various embodiments, the compound of formula (I) is preferably the sodium salt of a linear alkylbenzene sulfonate.

As already mentioned above, surfactants that contain aromatic structural units of this kind are, however, contained in the agent (together with surfactants containing carboxylate groups) in an amount of less than 10 wt. %, based on the total weight of said agent.

Preferred anionic surfactants are those of formula (II)

R¹—O-(AO)ₙ-SO₃⁻X⁺ (II).

In formula (II), R¹ stands for a linear or branched, substituted or unsubstituted alkyl functional group, preferably for a linear, unsubstituted alkyl functional group, particularly preferably for a fatty alcohol functional group. Preferred functional groups R¹ are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R¹ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols. X stands for a monovalent cation or the n-th part of an n-valent cation, the alkali metal ions, including Na⁺ or K⁺, being preferred in this case, with Na⁺ being particularly preferred. Other cations X⁺ may be selected from NH4⁺, ½ Zn²⁻, ½ Mg²⁺, ½ Ca²⁺, ½ Mn²⁺, and mixtures thereof.

AO stands for an ethylene oxide (EO) group or propylene oxide (PO) group, preferably for an ethylene oxide group. The index n stands for an integer from 1 to 50, preferably from 1 to 20, and in particular from 2 to 10. Very particularly preferably, n stands for the numbers 2, 3, 4, 5, 6, 7 or 8. X stands for a monovalent cation or the n-th part of an n-valent cation, the alkali metal ions, including Na⁺ or K⁺, being preferred in this case, with Na⁺ being particularly preferred. Other cations X⁺ may be selected from NH4⁻, ½ Zn²⁺, ½ Mg²⁺, ½ Ca²⁺, ½ Mn²⁺, and mixtures thereof.

In summary, in various embodiments, agents can therefore contain at least one anionic surfactant selected from fatty alcohol ether sulfates of formula (II-1)

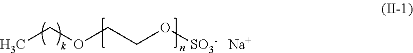

where k=11 to 19 and n=2, 3, 4, 5, 6, 7 or 8. Particularly preferred representatives are Na—C₁₂₋₁₄ fatty alcohol ether sulfates having 2 EO (k=11-13, n=2 in formula (II-1)).

Other preferred anionic surfactants that can be used are the alkyl sulfates of formula

R²—O—SO₃⁻X⁺ (III).

In formula (III), R² stands for a linear or branched, substituted or unsubstituted alkyl functional group, preferably for a linear, unsubstituted alkyl functional group, particularly preferably for a fatty alcohol functional group. Preferred functional groups R² are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R² are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols. X stands for a monovalent cation or the n-th part of an n-valent cation, the alkali metal ions, including Na⁺ or K⁺, being preferred in this case, with Na⁺ being particularly preferred. Other cations X⁺ may be selected from NH4⁺, ½ Zn²⁺, ½ Mg²⁺, ½ Ca²⁺, ½ Mn²⁺, and mixtures thereof.

In various embodiments, these surfactants are selected from fatty alcohol sulfates of formula (III-1).

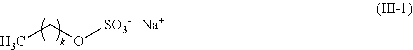

where k=11 to 19. Very particularly preferred representatives are Na—C₁₂₋₁₄ fatty alcohol sulfates (k=11-13 in formula (III-1)).

Other anionic surfactants that can be used are alkyl ester sulfonates, in particular those of formula (IV)

R¹—CH(SO₃⁻X⁺)—C(O)—O—R² (IV).

In formula (IV), R¹ stands for a linear or branched, substituted or unsubstituted alkyl functional group, preferably for a linear, unsubstituted alkyl functional group. Preferred functional groups R¹ are selected from nonyl, decyl, undecyl, dodecyl, tridecyl, tetradecyl, pentadecyl, hexadecyl, heptadecyl, octadecyl, nonadecyl, eicosyl, heneicosyl functional groups and mixtures thereof, the representatives having an odd number of C atoms being preferred. Particularly preferred functional groups R¹—CH are derived from C₁₂-C₁₈ fatty acids, for example from lauryl, myristyl, cetyl or stearyl acid. R² stands for a linear or branched, substituted or unsubstituted alkyl functional group, preferably for a linear, unsubstituted alkyl functional group. Preferred functional groups R² are C₁₋₆ alkyl functional groups, in particular methyl (=methyl ester sulfonates). X stands for a monovalent cation or the n-th part of an n-valent cation, the alkali metal ions, including Na⁺ or K⁺, being preferred in this case, with Na⁺ being particularly preferred. Other cations X⁺ may be selected from NH4+, ½ Zn²⁺, ½ Mg²⁺, ½ Ca²⁺, ½ Mn²⁺, and mixtures thereof.

Secondary alkane sulfonates are also suitable as anionic surfactants. These have, for example, formula (V)

R¹CH(SO₃⁻X⁺)R² (V),

R¹ and R² each independently being a linear or branched alkyl having 1 to 20 carbon atoms and forming, together with the carbon atom to which they are bound, a linear or branched alkyl, preferably comprising 10 to 30 carbon atoms, more preferably 10 to 20 carbon atoms, and X⁺ is selected from the group Na⁺, K⁺, NH4⁺, ½ Zn²⁺, ½ Mg²⁺, ½ Ca²⁺, ½ Mn²⁺, and mixtures thereof, preferably Na⁺.

In various preferred embodiments, the at least one secondary alkane sulfonate has the following formula (V-1)

H₃C—(CH₂)ₙ—CH(SO₃⁻X⁺)—(CH₂)ₘ—CH₃ (V-1)

where m and n are, independently of one another, an integer between 0 and 20. Preferably, m+n is an integer between 7 and 17, preferably between 10 and 14, and X⁺ is selected from the group Na⁺, K⁺, NH4⁺, ½ Zn²⁺, ½ Mg²⁺, ½ Ca²⁺, ½ Mn²⁺, and mixtures thereof, preferably Na⁺. In a particularly preferred embodiment, the at least one secondary alkane sulfonate is secondary C₁₄₋₁₇ sodium alkane sulfonate. A secondary C₁₄₋₁₇ sodium alkane sulfonate of this kind is marketed by Clariant, for example, under the tradename “Hostapur SAS60”.

As non-ionic surfactants, use can be made in particular of fatty alcohol alkoxylates. In various embodiments, the agents therefore contain at least one non-ionic surfactant of formula

R³—O-(AO)ₘ-H (VI),
in which
R³ stands for a linear or branched, substituted or unsubstituted alkyl functional group,
AO stands for an ethylene oxide (EO) group or propylene oxide (PO) group,
m stands for integers from 1 to 50.

In the aforementioned formula (VI), R³ stands for a linear or branched, substituted or unsubstituted alkyl functional group, preferably for a linear, unsubstituted alkyl functional group, particularly preferably for a fatty alcohol functional group. Preferred functional groups R² are selected from decyl, undecyl, dodecyl, tridecyl, tetradecyl, pentadecyl, hexadecyl, heptadecyl, octadecyl, nonadecyl, eicosyl functional groups and mixtures thereof, the representatives having an even number of C atoms being preferred. Particularly preferred functional groups R³ are derived from C₁₂-C₁₈ fatty alcohols, for example from coconut fatty alcohol, tallow fatty alcohol, lauryl, myristyl, cetyl or stearyl alcohol or from C₁₀-C₂₀ oxo alcohols.

AO stands for an ethylene oxide (EO) group or propylene oxide (PO) group, preferably for an ethylene oxide group. The index m stands for an integer from 1 to 50, preferably from 1 to 20, and in particular from 2 to 10. Very particularly preferably, m stands for the numbers 2, 3, 4, 5, 6, 7 or 8.

In summary, fatty alcohol alkoxylates that can preferably be used are compounds of formula

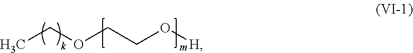

where k=11 to 19, n=2, 3, 4, 5, 6, 7 or 8. Very particularly preferred representatives are C₁₂₋₁₈ fatty alcohols having 7 EO (k=11-17, m=7 in formula (VI-1)).

Amine oxides, for example, are also suitable as non-ionic surfactants. In principle, all the amine oxides found in the prior art for this purpose, i.e. compounds that have the formula R¹R²R³NO, where each of R¹, R² and R³ are, independently of one another, an optionally substituted, for example hydroxy-substituted, C₁-C₃₀ hydrocarbon chain, can be used as said amine oxides. Amine oxides that are particularly preferably used are those in which R¹ is C₁₂-C₁₈ alkyl and R² and R³ are each independently C₁-C₄ alkyl, in particular C₁₂-C₁₈ alkyl dimethyl amine oxides. Example representatives of suitable amine oxides are N-coconut alkyl-N,N-dimethyl amine oxide, N-tallow alkyl-N,N-dihydroxyethyl amine oxide, myristyl/cetyl dimethyl amine oxide or lauryl dimethyl amine oxide.

Other non-ionic surfactants that can be contained in the described agents within the meaning of the present invention include, but are not limited to, alkyl glycosides, alkoxylated fatty acid alkyl esters, fatty acid alkanolamides, hydroxy mixed ethers, sorbitan fatty acid esters, polyhydroxy fatty acid amides and alkoxylated alcohols. Surfactants of this kind are known in the prior art.

Suitable alkyl(poly)glycosides are for example those of formula R²O-[G]ₚ, in which R² is a branched alkyl having 12 to 16 carbon atoms, G is a sugar residue having 5 or 6 carbon atoms, in particular glucose, and the index p is between 1 and 10.

Suitable amphoteric surfactants are, for example, betaines of formula (Rⁱⁱⁱ)(R^{iv})(R^{v})N⁺CH₂COO⁻, in which Rⁱⁱⁱ denotes an alkyl functional group, which is optionally interrupted by heteroatoms or heteroatom groups, having 8 to 25, preferably 10 to 21, carbon atoms, and R^{iv} and R^{v} denote identical or different alkyl functional groups having 1 to 3 carbon atoms, in particular C₁₀-C₁₈ alkyl dimethyl carboxymethyl betaine and C₁₁-C₁₇ alkyl amido propyl dimethyl carboxymethyl betaine.

Suitable cationic surfactants are, inter alia, the quaternary ammonium compounds of formula (R^{vi})(R^{vii})(R^{viii})(R^{ix})N⁺X⁻, in which R^{vi} to R^{ix} denote four identical or different, and in particular two long-chain and two short-chain, alkyl functional groups, and X⁻ denotes an anion, in particular a halide ion, for example didecyl dimethyl ammonium chloride, alkyl benzyl didecyl ammonium chloride and mixtures thereof. Other suitable cationic surfactants are quaternary surface-active compounds, in particular comprising a sulfonium, phosphonium, iodonium or arsonium group, which are also known as antimicrobial active ingredients. By using quaternary surface-active compounds having an antimicrobial effect, the agent can be formed having an antimicrobial effect, or the antimicrobial effect thereof that may already be present owing to other ingredients can be improved.

In various embodiments, the total amount of surfactants, i.e. the surfactant mixture, is from 5 to 75 wt. %, preferably from 5 to 35 wt. %, more preferably from 10 to 30 wt. %, based on the total weight of the agent.

As already mentioned above, the agents of the invention contain less than 10 wt. % of surfactants, based on the total weight of the agent, which contain an aromatic hydrocarbon structural unit and/or a carboxylate structural unit. Examples of surfactants that contain aromatic hydrocarbon structural units are the alkyl benzene sulfonates of formula (I) described above.

In preferred embodiments of the invention, the surfactant mixture contains more than 10 wt. % of surfactants, based on the total weight of the surfactant mixture, which contain an aliphatic hydrocarbon structural unit and/or an ethylene oxide structural unit.

In various embodiments of the invention, the surfactant mixture contains at least one alkyl ester sulfonate, preferably methyl ester sulfonate, at least one amine oxide, and optionally at least one alkyl ether, the surfactants being defined as above in each case.

In various embodiments, the agent can contain a surfactant mixture, for example, which consists in equal parts of C₁₆₋₁₈ methyl ester sulfonate, C₁₂₋₁₄ alkyl ethers having 7 EO and lauryl dimethyl amine oxide. In this case, the surfactants contain the structural units X₁ (C12-14 alkyl functional group), X₃ (ethylene oxide), X₄ (sulfonate) and X₅ (amine oxide, dimethyl). M_{TP} for the aliphatic hydrocarbon structural units in the methyl ester sulfonates, alkyl ethers and amine oxides is therefore, in each case, 1/3 (A_{TP}=1, S_{TP}=1/3), and therefore X₁, i.e. the sum thereof, is 1. M_{TP} for the ethylene oxide units in the alkyl ethers is 7/3 (A_{TP}=7, S_{TP}=1/3), and therefore X₃ is also 7/3. M_{TP} for the sulfonate unit in the methyl ester sulfonates is 1/3 (A_{TP}=1, S_{TP}=1/3), and therefore X₄ is 1/3. M_{TP} for the structural units in the amine oxides is 2/3 (A_{TP}=2, S_{TP}=0.1/3), and therefore X₅ is 2/3. X₂ and X₆ are each 0. Therefore, the following applies when these values are put into the above-described condition: 20(1)−30(0)+40(7/3)−80(1/3)+(2/3)−20(0)>0, i.e. 87.33>0. The condition is therefore met.

In other preferred embodiments, the agent according to the invention is characterized in that said agent contains
(a) 5-75 wt. %, preferably 5-35 wt. %, of surfactants, based on the total weight of the agent,
(b) 0.01-50 wt. %, preferably 0.5-30 wt. %, of ethoxylated polyethyleneimine (PEI), based on the total weight of the agent, and/or
(c) 0.00001-1 wt. %, preferably 0.0001-0.2 wt. %, of enzyme (active protein), based on the total weight of the agent.

Ethoxylated polyethyleneimines are used in particular as dirt-dispersing agents. Suitable ethoxylated polyethyleneimines are known, for example, from U.S. Pat. No. 5,565,145 A.

The agents according to the invention, which may be present in the form of powdered solids, compressed particles, homogeneous solutions or suspensions, can contain, in addition to the above-described ingredients, all known ingredients that are common in agents of this kind, at least one further ingredient preferably being present in the agent. The agents according to the invention may contain builders, bleaching agents, in particular peroxygen compounds or bleach activators, in particular. They may also contain water-miscible organic solvents, sequestering agents, electrolytes, pH regulators and/or further auxiliary agents such as optical brighteners, graying inhibitors, foam regulators, and dyes and fragrances, and combinations thereof.

In particular, a combination of the agent according to the invention with one or more further ingredient(s) is advantageous, since an agent of this kind has improved cleaning performance in preferred embodiments according to the invention on account of synergies obtained thereby. In particular, such synergy can be achieved by the combination of the agent according to the invention with a builder and/or a peroxygen compound and/or a bleach activator.

Advantageous ingredients of agents according to the invention are disclosed in international patent application WO2009/121725, starting on the penultimate paragraph of page 5 and ending on page 13 after the second paragraph. Reference is made explicitly to this disclosure and the content thereof is incorporated in the present patent application.

In preferred embodiments, the agent according to the invention is a washing agent, particularly preferably a liquid washing agent.

In one embodiment, the agents according to the present invention are liquid and contain water as the main solvent, i.e. they are aqueous agents. The water content of the aqueous agent according to the invention is usually from 15 to 70% wt. %, preferably from 20 to 60 wt. %. In various embodiments, the water content is more than 5 wt. %, preferably more than 15 wt. % and particularly preferably more than 50 wt. %, based in each case on the total amount of agent.

In addition, non-aqueous solvents may be added to the agent. Suitable non-aqueous solvents include monovalent or polyvalent alcohols, alkanolamines or glycol ethers, if they can be mixed with water in the stated concentration range. Preferably, the solvents are selected from ethanol, n-propanol, i-propanol, butanols, glycol, propanediol, butanediol, methylpropanediol, glycerol, diglycol, propyl diglycol, butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl ether, propylene glycol ethyl ether, propylene glycol propyl ether, dipropylene glycol mono methyl ether, dipropylene glycol mono ethyl ether, methoxytriglycol, ethoxytriglycol, butoxytriglycol, 1-butoxyethoxy-2-propanol, 3-methyl-3-methoxybutanol, propylene-glycol-t-butyl ether, di-n-octyl ether, and mixtures of these solvents.

The one or more non-aqueous solvents are usually contained in an amount of from 0.1 to 60 wt. %, preferably from 5 to 60 wt. %, more preferably from 10 to 30 wt. %, based on the total composition.

In addition to the aforementioned components, the agents according to the invention may contain further ingredients which further improve the practical and/or aesthetic properties of the agent. These include, for example, additives for improving flow and drying behavior, for adjusting viscosity and/or for stabilization, and other auxiliary agents and additives that are common in washing and cleaning agents, for example UV stabilizers, pearlescing agents, corrosion inhibitors, preservatives, bitterns, organic salts, disinfectants, (structural) polymers, defoamers, encapsulated ingredients (e.g. encapsulated perfume), pH adjusters and additives which improve feeling on skin or have a nourishing effect.

An agent according to the invention preferably contains at least one water-soluble and/or water-insoluble, organic and/or inorganic builder.

Builders that can generally be used include, in particular, amino carboxylic acids and salts thereof, zeolites, silicates, carbonates, organic (co)builders, and phosphates (provided that there are no environmental reasons for not using them). The agents are preferably phosphate-free, however.

The water-soluble organic builders include polycarboxylic acids, in particular citric acid and saccharic acids, monomeric and polymeric aminopolycarboxylic acids, in particular methylglycinediacetic acid, nitrilotriacetic acid, ethylenediaminetetraacetic acid and polyaspartic acid, polyphosphonic acids, in particular amino tris(methylenephosphonic acid), ethylenediamine tetrakis(methylenephosphonic acid), and 1-hydroxyethane-1,1-diphosphonic acid, polymeric hydroxy compounds such as dextrin, and polymeric (poly)carboxylic acids, polymeric acrylic acids, methacrylic acids, maleic acids, and mixed polymers thereof, which may also contain small portions of polymerizable substances, without a carboxylic acid functionality, in the polymer. Other compounds of this class which are suitable, although less preferred, are copolymers of acrylic acid or methacrylic acid with vinyl ethers, such as vinyl methyl ethers, vinyl esters, ethylene, propylene, and styrene, in which the proportion of the acid is at least 50 wt. %. All indicated acids are generally used in the form of water-soluble salts thereof, in particular alkali salts thereof.

In particular alkali silicates and polyphosphates, preferably sodium triphosphate, are suitable as water-soluble inorganic builder materials. In particular crystalline or amorphous alkali aluminosilicates may be used as water-insoluble, water-dispersible inorganic builder materials. Among these, crystalline sodium aluminosilicates of washing agent quality, in particular zeolite A, P and optionally X, are preferred. Suitable aluminosilicates have in particular no particles having a particle size greater than 30 μm and preferably comprise at least 80 wt. % of particles having a size smaller than 10 μm.

Suitable substitutes or partial substitutes for the stated aluminosilicate are crystalline alkali silicates, which may be present alone or in a mixture with amorphous silicates. The alkali silicates that are usable in the agents according to the invention as builders preferably have a molar ratio of alkali oxide to SiO₂ of less than 0.95, in particular from 1:1.1 to 1:12, and may be present in amorphous or crystalline form. Preferred alkali silicates are sodium silicates, in particular amorphous sodium silicates having a Na₂O:SiO₂ molar ratio of from 1:2 to 1:2.8. Preferably used as crystalline silicates, which may be present alone or in a mixture with amorphous silicates, are crystalline phyllosilicates of general formula Na₂SiₓO₂ₓ₊₁.y H₂O, in which x, referred to as the module, is a number from 1.9 to 4, y is a number from 0 to 20, and preferred values for x are 2, 3 or 4. Preferred crystalline phyllosilicates are those in which x in the stated general formula assumes the values 2 or 3. In particular, both beta-sodium and delta-sodium disilicates (Na₂Si₂O₅.y H₂O ) are preferred. Practically water-free crystalline alkali silicates of the above general formula, in which x is a number from 1.9 to 2.1 and which are produced from amorphous alkali silicates, may also be used in agents according to the invention. In a further preferred embodiment of agents according to the invention, a crystalline sodium phyllosilicate having a module of from 2 to 3, as can be produced from sand and soda, is used. Crystalline sodium silicates having a module in the range of from 1.9 to 3.5 are used in a further preferred embodiment of agents according to the invention. If alkali aluminosilicate, in particular zeolite, is also present as an additional builder, the weight ratio of aluminosilicate to silicate, based in each case on water-free active substances, is preferably from 1:10 to 10:1. In agents containing both amorphous and crystalline alkali silicates, the weight ratio of amorphous alkali silicate to crystalline alkali silicate is preferably from 1:2 to 2:1 and in particular from 1:1 to 2:1.

The aforementioned embodiments of the present invention cover all solid, powder, liquid, gel or paste dosage forms of agents according to the invention that may optionally also consist of a plurality of phases, and may be present in compressed or uncompressed form. The agent may be present in the form of a flowable powder, in particular having a bulk density of from 300 g/l to 1200 g/l, more particularly from 500 g/l to 900 g/l or from 600 g/l to 850 g/l. The solid dosage forms of the agent also include extrudates, granules, tablets or pouches. Alternatively, the agent may also be a liquid, gel or paste, for example in the form of a non-aqueous liquid washing agent or a non-aqueous paste or in the form of an aqueous liquid washing agent or water-containing paste. Furthermore, the agent may be present as a single-component system. Agents of this kind consist of one phase. Alternatively, an agent can also consist of a plurality of phases. An agent of this kind is therefore divided into a plurality of components.

A further object of the invention is a method for cleaning textiles or hard surfaces, characterized in that an agent according to the invention is used in at least one method step.

These embodiments include both manual and automatic methods, automatic methods being preferred. Methods for cleaning textiles are generally distinguished in that various substances that have a cleaning effect are applied to the item to be cleaned in a plurality of method steps and washed off after the contact time, or in that the item to be cleaned is treated with a washing agent or a solution or dilution of this agent in some other way. The same applies to methods for cleaning all materials other than textiles, in particular hard surfaces. All conceivable washing or cleaning methods can be enhanced in at least one of the method steps by the use of a washing or cleaning agent according to the invention, and then constitute embodiments of the present invention. All elements, objects and embodiments that are described for agents according to the invention can also be applied to this object of the invention.

Therefore, at this juncture, reference is explicitly made to the disclosure at the corresponding point when it was indicated that this disclosure also applies to the above methods according to the invention.

Methods for treating textile raw materials or for textile care in which an agent according to the invention becomes active in at least one method step also constitute alternative embodiments of this object of the invention.

Furthermore, the invention also relates to the use of the agent described herein for removing stains.

All elements, objects and embodiments that are described for agents according to the invention can also be applied to the use according to the invention. Therefore, at this juncture, reference is explicitly made to the disclosure at the corresponding point when it was indicated that this disclosure also applies to the uses according to the invention.

### EXAMPLES

### Example 1

### Stability of the Protease PUR in Combination with Surfactants

The surfactant-enzyme mixtures contained 1 wt. % of the surfactant in question.
Incubation at 40° C., pH 8.0
Half life (t_{1/2}) in minutes in linear regression, assuming pseudo second order

| Surfactant | t_{1/2} |
|---|---|
| C12-14 fatty alcohol ethoxylate 2 EO sulfate, Na salt | 770 |
| C9-13 alkylbenzene sulfonate, Na salt | 2 |
| C12-14 fatty alcohol having 7 EO | 6600 |
| Rhamnolipid (R90L; Agae Technologies) | 2000 |
| C16-18 methyl ester sulfonate (MES) | 475 |
| C12-14 fatty alcohol sulfate, Na salt | 290 |
| C12 amine oxide | 1100 |
| C12-18 betaines | 500 |

### Example 2

### Washing Tests

Test in respect of stain removal performance: relative change in remission in relation to the initial value in %; the average was taken for 27 test stains in accordance with the AISE protocol; testing in a Miele W918 washing machine, 60 min main wash cycle, 30° C., water hardness 16° dH, 3.5 kg prewashed standard cotton textiles as the load with ballast soil.

What was measured was the average stain removal performance of the individual surfactants having a mixture of commercial enzymes (PUR, Stainzyme, Mannaway, Lipex) by comparison with the average stain removal performance of individual surfactants without surfactants. The delta REM value was calculated herefrom.

| Compound | Delta REM |
|---|---|
| C12-14 fatty alcohol ethoxylate 2 EO sulfate, Na salt | 13.5 |
| C9-13 alkylbenzene sulfonate, Na salt | 6 |
| C12-14 fatty alcohol having 7 EO | 13 |
| Rhamnolipid (R90L; Agae Technologies) | 6 |
| C16-18 methyl ester sulfonate (MES) | 8 |
| C12-14 fatty alcohol sulfate, Na salt | 8 |
| C12 amine oxides | 11.5 |
| C12-18 betaines | 9 |

### Example 3

### Multiple Regression of Storage Tests and Washing Tests

Multiple regression of the storage tests and washing tests resulted in the described parameterization. The structural chemical building blocks (structural units) of the surfactants could be defined as follows in respect of their contribution to stability and cleaning performance in relative units:
CHx (aliphatic)=+20
CHx (aromatic)=−30
—(C₂H₄—O)— (ethylene oxide)=+40
SO₃⁻ or SO₄⁻ Na⁺ (sulf(on)ate)=−80
C═O, NCH₃, N(CH₃)₂, N═O=0
COO⁻Na³¹ =−20

The following relationship between the structural units was established for an optimum surfactant mixture:

20.X₁−30.X₂+40.X₃−80.X₄+0.X₅−20.X₆>0,

where X₁, X₂, X₃, X₄, X₅ and X₆ stand for the multiples (total amount) of the present structural units of all surfactants.

### Example 4

### Formulations

The following shows the variants E1-E4 of the agents according to the invention (amounts in wt. %):

| | Variant | Variant | Variant | Variant |
|---|---|---|---|---|
| Ingredient | E1 | E2 | E3 | E4 |
| C12-14 fatty alcohol 2 EO | 11 | 9 | 9 | 11 |
| sulfate, Na salt | | | | |
| C9-13 alkylbenzene sulfonate, | — | — | 2 | 3 |
| Na salt | | | | |
| C12-14 fatty alcohol having | 17.5 | 17.5 | 13 | 7 |
| 7 EO | | | | |
| C16-18 methyl ester sulfonate | — | — | 7 | 10 |
| (MES) | | | | |
| C12 amine oxides | — | 2 | — | — |
| Ethoxylated polyethyleneimine | 12 | 12 | 12 | 12 |
| (PEI) (Sokalan HP 20, BASF) | | | | |
| C12-C18 fatty acid, Na salt | 8 | 8 | 8 | 8 |
| PVA/maleic acid copolymer | — | — | 2 | — |
| Phosphonic acid, Na salt | 0.5 | 0.5 | 0.5 | 0.5 |
| Glycerol | 8 | 8 | 8 | 8 |
| PEG 200 | 3 | 3 | 3 | 3 |
| C13-15 fatty alcohol having | — | 20 | 15 | — |
| 8 EO | | | | |
| Silicone defoamer | 0.1 | 0.1 | 0.1 | 0.1 |
| Enzymes (amylase, protease, | 1.5 | 1.5 | 1.5 | 1.5 |
| cellulase, lipase, mannanase, | | | | |
| pectatlyase) | | | | |
| Boric acid | 1.0 | 1.0 | 1.0 | 1.0 |
| Dye | 0.0001- | 0.0001- | 0.0001- | 0.0001- |
| | 0.1 | 0.1 | 0.1 | 0.1 |
| Shading Dye | 0.0001- | 0.0001- | 0.0001- | 0.0001- |
| | 0.1 | 0.1 | 0.1 | 0.1 |
| Soil-release polymer | 2 | 2 | 2 | 2 |
| (Texcare SRN 170, Clariant) | | | | |
| Perfume | 0.6 | 0.6 | 0.6 | 0.6 |
| Optical brightener | 0.3 | 0.3 | 0.3 | 0.3 |
| Propylene glycol | to 100 | to 100 | to 100 | to 100 |

What is claimed is:

1. An agent comprising:
(a) at least one enzyme, and
(b) a surfactant mixture,
wherein
(i) the surfactant mixture comprises at least one non-ionic surfactant and at least one anionic surfactant,
(ii) the surfactant mixture comprises less than 10 wt. % of surfactants, based on the total weight of the agent, which contain an aromatic hydrocarbon structural unit and/or a carboxylate structural unit, and
(iii) the surfactant mixture meets the condition:
20.X₁31.X₂+40.X₃−80.X₄+0.X₅−20.X₆>0,
wherein
X₁ corresponds to the total number of aliphatic hydrocarbon structural units of all surfactants,
X₂ corresponds to the total number of aromatic hydrocarbon structural units of all surfactants,
X₃ corresponds to the total number of ethylene oxide structural units of all surfactants,
X₄ corresponds to the total number of sulf(on)ate structural units (SO₃⁻/SO₄⁻) of all surfactants,
X₅ corresponds to the total number of structural units selected from the group consisting of C═O, N—CH₃, N(CH₃)₂ and N═O of all surfactants,
X₆ corresponds to the total number of carboxylate structural units (COO⁻) of all surfactants,
and
wherein
(i) the total number of relevant structural unit equates to the sum of the amounts of a given structural unit in various given surfactant populations, and
(ii) the amount of the given structural unit in a given surfactant population (M_{TP}) is the product of the number of occurrences of the given structural unit in an individual surfactant of the given surfactant population (A_{TP}) and the substance proportion of the given surfactant population (S_{TP}) relative to the total amount of the surfactant mixture, wherein this corresponds to M_{TP}=A_{TP}·S_{TP}.

2. The agent according to claim 1, wherein the surfactant mixture contains more than 10 wt. % of surfactants, based on the total weight of the surfactant mixture, which contain an aliphatic hydrocarbon structural unit and/or an ethylene oxide structural unit.

3. The agent according to claim 1, characterized in that the agent comprises
(a) 5-75 wt. % of surfactants, based on the total weight of the agent,
(b) 0.01-50 wt. % of ethoxylated polyethyleneimine (PEI), based on the total weight of the agent, and
(c) 0.00001-1 wt. % of enzyme (active protein), based on the total weight of the agent.

4. The agent according to claim 1, wherein the enzyme is a protease.

5. The agent according to claim 1, characterized in that the agent is a washing agent.

6. A method for cleaning textiles or hard surfaces, comprising the step wherein an agent according to claim 1 is contacted with a textile in a wash liquor.
